(19) United States
(12) Patent Application Publication
(10) Pub. No.: US 2025/0312914 A1
(43) Pub. Date: Oct. 9, 2025

(54) TRANSFORMER DIFFUSION FOR ROBOTIC TASK LEARNING

(71) Applicant: GDM Holding LLC, Mountain View, CA (US)

(72) Inventors: Zihao Zhao, Cupertino, CA (US); Jonathan Tompson, San Carlos, CA (US); Danny Michael Driess, San Francisco, CA (US); Peter Raymond Florence, San Francisco, CA (US); Chelsea Finn, Berkeley, CA (US); Ayzaan Wahid, Yorba Linda, CA (US)

(21) Appl. No.: 19/173,425

(22) Filed: Apr. 8, 2025

Related U.S. Application Data
(60) Provisional application No. 63/631,340, filed on Apr. 8, 2024.

(51) Int. Cl. B25J 9/16

(52) U.S. Cl. CPC B25J 9/1612; B25J 9/161; B25J 9/163; B25J 9/1689

(57) ABSTRACT

Implementations are provided for learning dexterous tasks. In various implementations, a plurality of images may be retrieved that capture an environment in which a robot operates from multiple different perspectives. Data indicative of the plurality of images and a proprioceptive state of the robot may be processed using a diffusion model that includes a transformer-encoder and a transformer-decoder. The transformer-encoder may be used to generate latent embeddings representing the plurality of images and proprioceptive state of the robot. The transformer-decoder may be used to process the latent embeddings and data indicative of a diffusion timestep to generate robot control data. The robot control data may include a series of actions to be performed by the robot over a time interval. The robot may be operated in accordance with the robot control data.

### BACKGROUND

Dexterous manipulation tasks such as tying shoelaces or hanging t-shirts on a coat hanger have traditionally been seen as very difficult to achieve with robots. From a modeling perspective, dexterous manipulation tasks are challenging since they involve often deformable objects with complex contact dynamics, require many manipulation steps to solve the task, and/or involve the coordination of high-dimensional robotic manipulators, especially in bimanual setups, and generally often require high precision. Imitation learning has been used to obtain policies that can solve a wide variety of tasks. However, these policies have been predominantly trained for non-dexterous tasks such as pick and place or pushing. Therefore, it is unclear if simply scaling up imitation learning is sufficient for dexterous manipulation, since collecting a dataset that covers the state variation of the system with the required precision for such tasks seems prohibitive.

### SUMMARY

Implementations described here allow for the teaching of policies that are capable of solving highly dexterous, long-horizon, bimanual manipulation tasks that involve deformable objects and require high precision. To achieve this, a transformer-based learning architecture may be trained with a diffusion loss. Conditioned on multiple views, this architecture denoises a trajectory of actions, which is executed open-loop in a receding horizon setting. The result of the policy is robot control data that can be used to control a real or simulated robot.

“Robot control data” may include, for instance, low-level actuator commands (also referred to as “joint commands,” and may include torque commands) that directly control the actuators/joints of the robot, cartesian commands that specify direction(s) for an end effector, a target robot pose, code that specifies reward functions that a motion controller can optimize (e.g., using techniques such as receding horizon optimization) to find optimal low-level actuator commands, selected predefined robot primitives, and so forth.

In various implementations, one or more diffusion policies may be trained, e.g., on a task-by-task basis or for multiple tasks. These diffusion policies may each include, for instance, a transformer-encoder and a transformer-decoder. The inherent multimodality in dataset collected for purposes of carrying out selected aspects of the present disclosure may warrant an expressive policy formulation to fit the data. Accordingly, in some implementations, a separate diffusion policy may be learned for each task (e.g., folding a shirt, tying shoelaces, etc.).

A diffusion policy configured with selected aspects of the present disclosure may provide stable training and express multimodal action distributions with multimodal inputs (e.g., four images plus a robot's proprioceptive state) and n-degree-of-freedom action space (e.g., n may be equal to six, fourteen, etc.). In some implementations, action chunking may be performed to allow the diffusion policy to predict chunks of, for instance, 50 actions representing a trajectory spanning, for instance, one second. In some implementations, the diffusion policy may output some number (e.g., twelve) of absolute joint positions and a continuous value for the gripper position for each of two or more grippers.

Several implementations described herein relate to methods for performing selected aspects of the present disclosure. Other implementations may include a non-transitory computer readable storage medium storing instructions executable by a processor to perform a method such as one or more of the methods described herein. Yet another implementation may include a control system including memory and one or more processors operable to execute instructions, stored in the memory, to implement one or more modules or engines that, alone or collectively, perform a method such as one or more of the methods described herein.

It should be appreciated that all combinations of the foregoing concepts and additional concepts described in greater detail herein are contemplated as being part of the subject matter disclosed herein. For example, all combinations of claimed subject matter appearing at the end of this disclosure are contemplated as being part of the subject matter disclosed herein.

### BRIEF DESCRIPTION OF THE DRAWINGS

FIG. 1 schematically depicts an example environment in which selected aspects of the present disclosure may be implemented, in accordance with various implementations.

FIG. 2 schematically depicts an example robot, in accordance with various implementations.

FIG. 3 schematically depicts an example generative model architecture configured with selected aspects of the present disclosure, in accordance with various implementations.

FIG. 4 schematically depicts an example process for controlling a robot, e.g., with the generative model architecture of FIG. 3.

FIG. 5 schematically depicts an example process for training a generative model architecture such as that depicted in FIG. 3.

FIG. 6 is a block diagram of an example computer system.

### DETAILED DESCRIPTION

Various implementations described herein relate to an imitation learning system for training dexterous policies on robots. More particularly, but not exclusively, various implementations described here relate to a framework for scalable teleoperation that allows users to collect data to teach robots, combined with a transformer-based neural network trained as a diffusion policy, which provides an expressive policy formulation for imitation learning. With this recipe, it is possible to implement autonomous policies on various challenging real world tasks, such as hanging a shirt, tying shoelaces, replacing a robot finger, inserting gears, and stacking randomly initialized kitchen items. In some cases, the techniques described herein may be implemented using a bimanual parallel-jaw gripper work cell with two six-degree-of-freedom (DoF) arms, although this is not required.

With techniques described herein it is possible to obtain robot control policies that are capable of solving highly dexterous, long-horizon, bimanual manipulation tasks that involve deformable objects and require high precision. To achieve this, a protocol is described herein for collecting data on a scale previously unmatched by any bimanual manipulation platform. Various techniques described herein also incorporate the transformer-based learning architecture described above, which may be trained with a diffusion loss. Conditioned on multiple views, this transformer-based learning architecture may denoise a trajectory of actions, which can be executed as an open-loop in a receding horizon setting.

In various implementations, separate diffusion policies may be trained for each task. A diffusion policy provides stable training and expresses multimodal action distributions with multimodal inputs (e.g., four images from different viewpoints and proprioceptive state) and 14-DoF action space. Some implementations described herein may use the denoising diffusion implicit models (DDIM) formulation, which allows flexibility at test time to use a variable number of inference steps. Action chunking may be performed to allow the policy to predict chunks of, for example, fifty actions, representing a trajectory spanning, for instance, one second. The policy may output a number (e.g., twelve) of absolute joint positions, e.g., six for each six-DoF arm, and a continuous value for gripper position for each of two grippers. In implementations where the action chunks have a length of fifty, the policy may output a tensor of shape (50, 14). In some implementations, some number of diffusion steps (e.g., fifty) may be performed during training, with a squared cosine noise schedule.

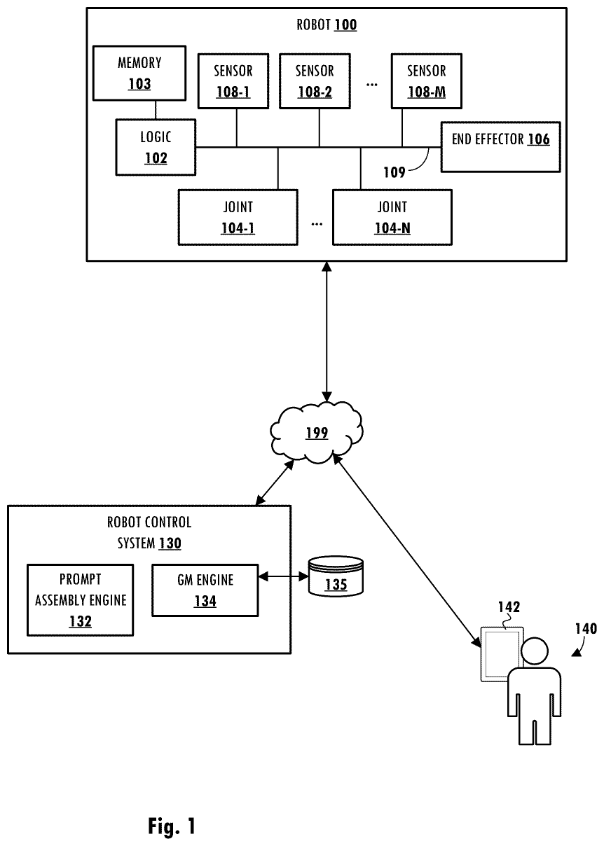

FIG. 1 is a schematic diagram of components that can cooperate to carry out selected aspects of the present disclosure, in accordance with various implementations. The various components depicted in FIG. 1, particularly those components forming a robot control system 130, may be implemented using any combination of hardware and software. The components of FIG. 1 are depicted as being communicatively coupled with each other via one or more networks 199, which may include one or more personal area networks, local area networks, and/or wide area networks (e.g., the Internet). However, this is not meant to be limiting. Various aspects of the present disclosure that are described as being performed by and/or stored on system 130 can alternatively be performed by and/or stored on robot 100 and/or client device 140.

Client device 142 may take various forms. In various implementations, it may be a personal computer (desktop or laptop), a mobile device such as handheld computer (e.g., personal digital assistant (PDA), e-reader, etc.), a tablet, a mobile phone, a microphone headset with built-in computing/processing capabilities and network access, and the like. In various implementations, client device 142 may host an interface (e.g., keyboard, touchscreen, or mouse, etc.) for a user to interact with robot 100. In some implementations, the robot control system 130 may be stored locally on robot 100 and accessed via a user interface provided on client device 142. In various implementations, user 140 may control robot 100 using client device 142.

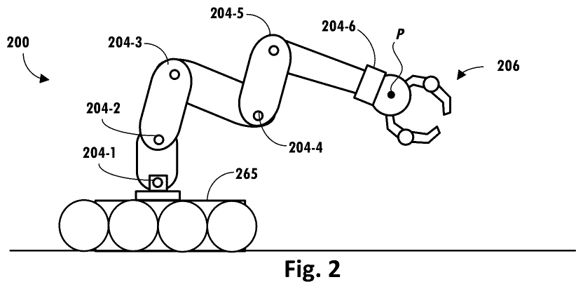

Robot 100 may take various forms, including but not limited to a telepresence robot (e.g., which may be as simple as a wheeled vehicle equipped with a display and a camera), a robot arm, a multi-pedal robot such as a “robot dog,” an aquatic robot, a wheeled device, a submersible vehicle, an unmanned aerial vehicle (“UAV”), and so forth. One non-limiting example of a mobile robot arm is depicted in FIG. 2. In various implementations, robot 100 may include logic 102. Logic 102 may take various forms, such as a real time controller, one or more processors, one or more field-programmable gate arrays (“FPGA”), one or more application-specific integrated circuits (“ASIC”), and so forth. In some implementations, logic 102 may be operably coupled with memory 103. Memory 103 may take various forms, such as random-access memory (“RAM”), dynamic RAM (“DRAM”), read-only memory (“ROM”), Magnetoresistive RAM (“MRAM”), resistive RAM (“RRAM”), NAND flash memory, and so forth. In some implementations, a robot controller may include, for instance, logic 102 and memory 103 of robot 100.

In some implementations, logic 102 may be operably coupled with one or more joints 104-1 to 104-N, one or more end effectors 106, and/or one or more sensors 108-1 to 108-M, e.g., via one or more buses 109. As used herein, “joint” 104 of a robot may broadly refer to actuators, motors (e.g., servo motors), shafts, gear trains, pumps (e.g., air or liquid), pistons, drives, propellers, flaps, rotors, or other components that may create and/or undergo propulsion, rotation, and/or motion. Some joints 104 may be independently controllable, although this is not required. In some instances, the more joints robot 100 has, the more degrees of freedom of movement it may have.

As used herein, “end effector” 106 may refer to a variety of tools that may be operated by robot 100 in order to accomplish various tasks. For example, some robots may be equipped with an end effector 106 that takes the form of a claw with two opposing “fingers” or “digits.” Such a claw is one type of “gripper” known as an “impactive” gripper. Other types of grippers may include but are not limited to “ingressive” (e.g., physically penetrating an object using pins, needles, etc.), “astrictive” (e.g., using suction or vacuum to pick up an object), or “contigutive” (e.g., using surface tension, freezing or adhesive to pick up object). More generally, other types of end effectors may include but are not limited to drills, brushes, force-torque sensors, cutting tools, deburring tools, welding torches, containers, trays, and so forth. In some implementations, end effector 106 may be removable, and various types of modular end effectors may be installed onto robot 100, depending on the circumstances. Some robots, such as some telepresence robots, may not be equipped with end effectors. Instead, some telepresence robots may include displays to render visual representations of the users controlling the telepresence robots, as well as speakers and/or microphones that facilitate the telepresence robot “acting” like the user.

Sensors 108-1 to 108-M may take various forms, including but not limited to 3D laser scanners (e.g., light detection and ranging, or “LIDAR”) or other 3D vision sensors (e.g., stereographic cameras used to perform stereo visual odometry) configured to provide depth measurements, two-dimensional cameras (e.g., RGB, infrared), light sensors (e.g., passive infrared), force sensors, pressure sensors, pressure wave sensors (e.g., microphones), proximity sensors (also referred to as “distance sensors”), depth sensors, torque sensors, barcode readers, radio frequency identification (“RFID”) readers, radars, range finders, accelerometers, gyroscopes, compasses, position coordinate sensors (e.g., global positioning system, or “GPS”), speedometers, edge detectors, Geiger counters, and so forth. While sensors 108-1 to 108-M are depicted as being integral with robot 100, this is not meant to be limiting.

In various implementations, robot control system 130 may include one or more computing devices cooperating to perform selected aspects of the present disclosure. Accordingly, although depicted in FIG. 1 as a single machine, robot control system 130 may include a group of machines each capable of performing all or a subset of the functions ascribed to robot control system 130 herein. For example, in some implementations, one or more of the components depicted in FIG. 1 may be omitted from robot control system 130 and/or one or more additional components not depicted in FIG. 1 may be added to robot control system 130. In some implementations, robot control system 130 may include one or more servers forming part of what is often referred to as a “cloud.”

Robot control system 130 may include a prompt assembly engine 132 and a generative model (GM) engine 134 with access to one or more generative models 135. Any of engines 132 and 134 may be implemented using any combination of hardware and software. In some implementations, one or more of engines 132 and 134 may be omitted. In some implementations, one or more additional engines may be included in addition to or instead of engines 132 and 134. In some implementations, one or more of engines 132 and 134, and/or other similar engines (not depicted) may be implemented separately from robot control system 130. In other implementations, one or more of engines 132 and 134, and/or other similar engines (not depicted) may be implemented together with each other and/or with engines 132 and 134.

Machine learning model(s) such as generative model(s) 135 may take various forms, including, but not limited to, generative model(s) such as PaLM, PaLM-E, Gemini, Gemini 2.0, BERT, LaMDA, Meena, and/or any other generative model, such as any other generative model that is encoder-decoder-based, encoder-only based, decoder-only based, sequence-to-sequence based and/or that optionally includes an attention mechanism or other memory. In generative model form, machine learning model(s) may have hundreds of millions, or even hundreds of billions of parameters. In some implementations, machine learning model(s) may include a multi-modal model such as a VLM and/or a visual question answering (VQA) model, which can have any of the aforementioned architectures, and which can be used to process multiple modalities of data, particularly images and text, and/or images and audio for example, to generate one or more modalities of output.

In some implementations, generative model(s) 135 may include a transformer-encoder to generate latent embeddings representing the plurality of robot images and proprioceptive state of the robot, and a transformer-decoder. The transformer-decoder may be used to process the latent embeddings and data indicative of a diffusion timestep to generate robot control data. The robot control data may include and/or represent a series of actions to be performed by the robot over a time interval. Robot control data may take various forms, such as low-level actuator commands, Cartesian commands for an end effector of the robot, a target robot pose, code specifying reward functions for motion controller optimization, and/or selected predefined robot primitives (e.g., a particular set, order, and type of robot primitives, such as “put a screw in a nut”).

In various implementations, prompt assembly engine 132 may be configured to assemble input prompts to be processed by GM engine 134 using generative model(s) 135. In some implementations, the input prompts may be received by prompt assembly engine 132 from a user via one or more input devices. In other implementations, the input prompts may be received from one or more other processes. These prompts may include, for instance task instructions(s), robot image(s) captured by sensors 108-1 to 108-M, and/or proprioceptive state(s) of robot 100. A proprioceptive state may describe all or portions of the state of the robot while it is in a current pose (e.g., the location of all or portions of the robot, the orientation of all or portions of the robot, the speed of all or portions of the robot, the torque imparted by all or portions of the robot, the pressure applied by all or portions of the robot, the temperature of all or portions of the robot, the position of all or portions of the robot, and/or the state of one or more joints of the robot). These state variables may be measured by sensors 108-1 to 108-M, and/or in any other way.

FIG. 2 depicts a non-limiting example of a robot 200 in the form of a robot arm. An end effector 206 in the form of a gripper claw is removably attached to a sixth joint 204-6 of robot 200. In this example, six joints 204-1 to 204-6 are indicated. However, this is not meant to be limiting, and robots may have any number of joints. In some implementations, robot 200 may be mobile, e.g., by virtue of a wheeled base 265 or other locomotive mechanism. Robot 200 is depicted in FIG. 2 in a particular selected configuration or “pose”.

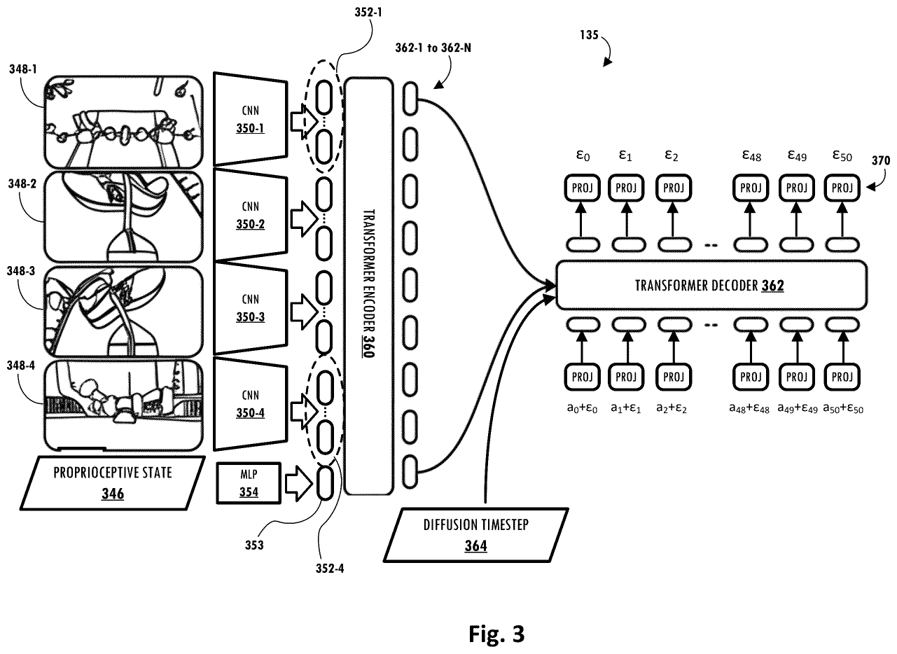

FIG. 3 schematically depicts one example of a generative model 135 architecture that may be employed with various implementations described herein. Images 348-1 to 348-4 and proprioceptive state 346 may be processed using, for instance, convolutional neural network(s) (CNNs) 350-1 to 350-4 and/or other vision module(s) in order to generate feature maps 352-1 to 352-4. Feature maps 352-1 to 352-4 may be flattened into tokens (not depicted) using, for instance, one or more embedding/attention modules (not depicted). These tokens may be processed using transformer encoder 360 in order to generate latent embeddings 362-1 to 362-N representing the plurality of images and proprioceptive states of the robot. Latent embeddings 362-1 to 362-N and a diffusion timestep 364 (e.g., a one-hot vector) may be processed using transformer decoder 362 in order to ultimately generate robot control data. In FIG. 3, for instance, a noisy action chunk a₀+ε₁, . . . , a₅₀+ε₅₀ with a learned positional embedding is cross attended with latent embeddings 362-1 to 362-N in order to predict noise εᵢ at each step i of the diffusion process implemented by transformer decoder 362. The predicted noise εᵢ may be used to “step back” along the diffusion process implemented by transformer-decoder 362. The model essentially subtracts the predicted noise Ei from the noisy input aᵢ+εᵢ, leaving the denoised action ai remaining.

In some implementations, CNNs 350-1 to 350-4 (e.g., ResNet50) may be used as a vision backbone. Each of multiple (e.g., four) RGB images may be resized, e.g., to 480×640×3, and fed into a separate CNN 350. Each CNN 350 may be initialized from, for instance, a pretrained classification model. The stage four output of the CNNs 350-1 to 350-4, which may result in a 15×20×512 feature map 352 for each image 348 in some implementations, may be taken. The feature map 352 may be flattened, resulting in, for example, 1,200 512-dimensional embeddings. Another embedding 353, which may be a projection of the proprioceptive state 346 of the robot (e.g., the joint positions and gripper values for each of the arms) created using a multilayer perceptron 354, may be appended (e.g., for a total of 1201 latent feature dimensions). Positional embeddings may be added to the embedding and fed into transformer-encoder 360 (e.g., having eighty-five million parameters in some cases) to encode the embeddings, with bidirectional attention, producing latent embeddings 362-1 to 362-N of the observations.

The latent embeddings 362-1 to 362-N may be passed into the transformer-decoder 362 (which is trained as a diffusion denoiser), which in some implementations may be a fifty-five million parameter transformer with bidirectional attention. The input of the transformer-decoder 362 may be a 50×14 tensor in some cases, corresponding to a noised action chunk a₀+ε₀, . . . , a₅₀+ε₅₀ with a learned positional embedding. These embeddings cross-attend to the latent embeddings 352-1 to 362-N of the transformer encoder 360 (also referred to as an “observation encoder”), as well as the diffusion timestep 364, which may be represented as a one-hot vector in some implementations.

Transformer decoder 362 may have an output dimension of, for instance, 50×512, which may be projected with a linear layer 370 into, for instance, a 50×14 output dimension; this may correspond to the predicted noise ε₀, . . . , ε₅₀ for the next fifty actions in the chunk. In total, the total architecture may include, for instance, two-hundred and seventeen million learnable parameters. In other implementations, a small variant of the model, which uses, for instance, a seventeen million parameter transformer encoder and a thirty-seven million parameter transformer decoder, with a total network size of one hundred fifty million parameters, may also be trained.

In some implementations, the models may be trained using some number (e.g., sixty-four) of tensor processing unit (TPU) chips with a data parallel mesh. A batch size of two hundred and fifty six may be used, and training may proceed for two million steps (about 265 hours of training). A weight decay of 0.001 may be used and a linear learning rate warmup for 5000 steps followed by a constant rate of 1e-4.

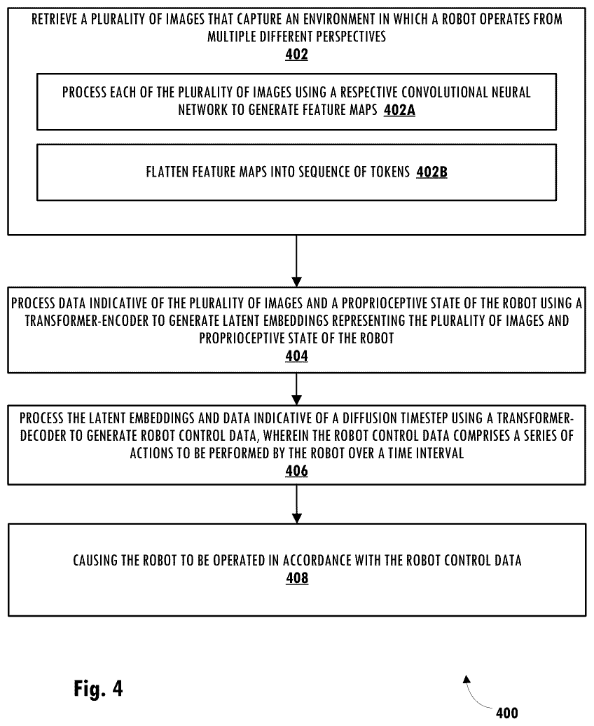

FIG. 4 depicts an example method 400 for practicing selected aspects of the present disclosure. For convenience, the operations of the flow chart are described with reference to a system that performs the operations. This system may include various components of various computer systems, including various components of system 130. Moreover, while operations of method 400 are shown in a particular order, this is not meant to be limiting. One or more operations may be reordered, omitted or added.

At block 402, the system may retrieve multiple images (e.g., 348-1 to 348-4) that capture an environment in which the robot 100 operates from multiple different perspectives. The images may be captured by sensors 108-1 to 108-M onboard robot 100 and/or deployed in the robot's environment.

In some implementations, the system may perform various types of preprocessing on the images. For example, at block 402A, the system may process each of the plurality of images using a respective CNN (e.g. 350-1 to 350-4) to generate feature maps, e.g., feature maps 352-1 to 352-4. Next, at block 402B, the system may flatten the feature maps into a sequence of tokens, e.g., using embedding/attention modules (not depicted). At block 404, the system may process data indicative of the multiple images 348-1 to 348-4 and a proprioceptive state 346 of the robot using a transformer-encoder 360 to generate latent embeddings 362-1 to 362-N representing the images and the proprioceptive state 346 of the robot.

At block 406, the system may process the latent embeddings 362-1 to 362-N and data indicative of a diffusion timestep 364 using transformer-decoder 362 to ultimately generate robot control data that includes a series of actions to be performed by the robot over a time interval. In some implementations, the transformer-encoder 360 and transformer-decoder 362 may form a diffusion policy. For example, in some implementations, the transformer-decoder 362 may include a diffusion denoiser. In many implementations, the diffusion timestep 364 may be represented as a one-hot vector. The robot 100 may be a simulated robot or a real robot. The series of actions may include a series of absolute joint positions of multiple joints 104-4 to 104-N of the robot 100. The series of actions may additionally or alternatively include a series of (e.g., continuous) gripper positions for two or more grippers. As noted above, in some implementations, the robot control data may be generated by predicting noise values (e.g., ε₁−ε₅₀) using transformer-decoder 362, and then subtracting the predicted noise values εᵢ from the noisy input aᵢ+εᵢ, leaving the denoised action ai remaining.

At block 408, the system may cause the robot to be operated in accordance with the robot control data. The series of actions may include joint commands and/or torque commands, Cartesian commands for an end effector 106 of the robot, a target robot pose, code specifying reward functions for motion controller optimization, or selected predefined robot primitives.

In some implementations, one or both of the transformer-encoder 360 and transformer decoder 362 may be trained using training data collected using imitation learning. The imitation learning may include teleoperation of one or more robots using a puppeteering interface. In some cases, the puppeteering interface may include two leader arms of a first size that are synchronized with two follower arms of a second size that is greater than the first size. The imitation learning may include tasks such as the following: folding a shirt, hanging a shirt on a hanger, shoelace tying, robot finger placement, gear insertion, or stacking random collections of dishware.

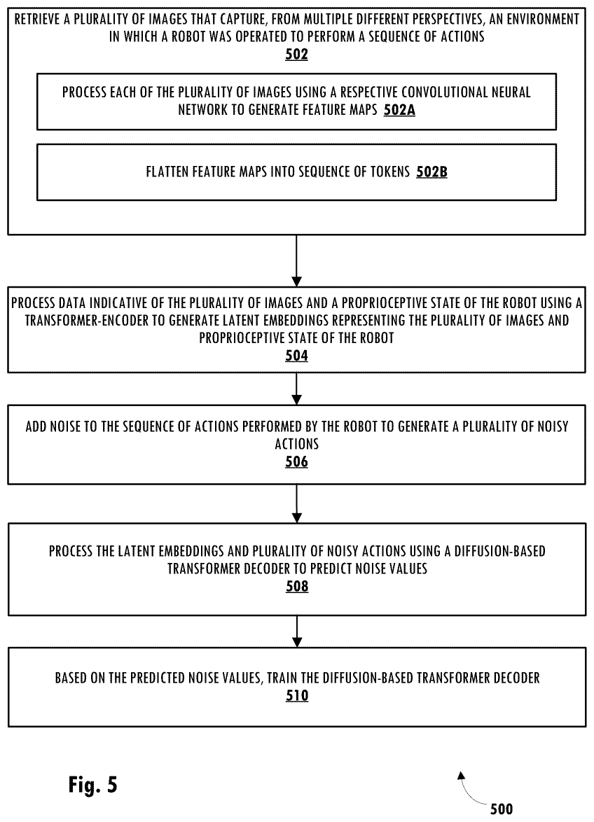

FIG. 5 depicts another example method 500 for practicing selected aspects of the present disclosure, including training one or more of the generative models described herein. For convenience, the operations of the flow chart are described with reference to a system that performs the operations. This system may include various components of various computer systems, including various components of system 130. Moreover, while operations of method 500 are shown in a particular order, this is not meant to be limiting. One or more operations may be reordered, omitted or added.

At block 502, the system may retrieve a plurality of images (e.g., 348-1 to 348-4) that capture, from multiple different perspectives, an environment (real or simulated) in which a robot (e.g., 100, 200) was operated to perform a sequence of actions (e.g., a₀, . . . , a₅₀). These images may have been captured by the sensors 108-1 to 108-M onboard the robot and/or by sensors deployed in the robot's environment. Similar to method 400, in some implementations, at block 502A, the system may process each of the plurality of images using a respective CNN (e.g., 350-1 to 350-4) to generate feature maps 352-1 to 352-4. At block 502B, the system may flatten the feature maps into tokens (e.g., using embedding/attention modules).

At block 504, the system may process data indicative of the plurality of images 348-1 to 348-4 and a proprioceptive state 346 of the robot using a transformer-encoder 360 to generate latent embeddings 362-1 to 362-N representing the images and the proprioceptive state of the robot. The proprioceptive state may have been captured prior to the robot being operated to perform the sequence of actions.

At block 506, the system may add noise to the sequence of actions (e.g., a₀, . . . , a₅₀) performed by the robot to generate a plurality of noisy actions (e.g., a₀+ε₀, . . . , a₅₀+ε₅₀). The noise that is added to the sequence of actions performed by the robot may be random noise such as Gaussian noise.

At block 508, the system may process the latent embeddings and the plurality of noisy actions using a diffusion-based transformer decoder 362 to predict noise values (e.g., ε₁, . . . , ε₅₀). This may be referred to as a denoising process because in some cases, the transformer-decoder 362 is trained using diffusion loss.

At block 510, the system may train the diffusion-based transformer decoder 362 based on the predicted noise values (e.g., ε₁, . . . , ε₅₀). In some implementations, predicted actions may be determined using the predicted noise values (e.g., ε₁, . . . , ε₅₀) and the diffusion-based transformer-decoder 362 may be trained based on a comparison of the predicted actions and the sequence of actions (e.g., a₀, . . . , a₅₀) performed by the robot. For example, the predicted noise may be used to “step back” along the diffusion process implemented by transformer-decoder 362. The model may essentially subtract the predicted noise (e.g., ε₁, . . . , ε₅₀) from the noisy input (e.g., a₀+ε₀, . . . , a₅₀+ε₅₀), leaving the denoised action (e.g., a₀, . . . , a₅₀) remaining.

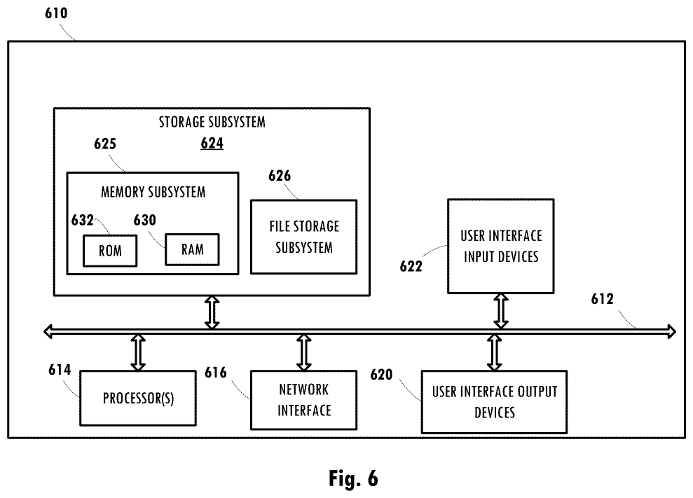

FIG. 6 is a block diagram illustrating an example computing device 610 in accordance with various implementations. Computing device 610 typically includes at least one processor 614 and a system memory 616 which communicates with a number of peripheral devices via bus subsystem 612. These peripheral devices may include a storage subsystem 624, including, for example, a memory subsystem 625 and a file storage subsystem 626, user interface output devices 620, user interface input devices 622, and a network interface subsystem 616. The input and output devices allow user interaction with computing device 610. Network interface subsystem 616 provides an interface to outside networks and is coupled to corresponding interface devices in other computing devices.

User interface input devices 622 may include a keyboard, pointing devices such as a mouse, trackball, touchpad, or graphics tablet, a scanner, a touchscreen incorporated into the display, audio input devices such as voice recognition systems, microphones, and/or other types of input devices. In general, use of the term “input device” is intended to include all possible types of devices and ways to input information into computing device 610 or onto a communication network.

User interface output devices 620 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computing device 610 to the user or to another machine or computing device.

Storage subsystem 624 stores programming and data constructs that provide the functionality of some or all of the modules described herein. For example, the storage subsystem 624 may include the logic to perform selected aspects of the methods 700, 800, 900, and 1000 described herein.

These software modules are generally executed by processor 614 alone or in combination with other processors. Memory 625 used in the storage subsystem 624 can include a number of memories including a main random-access memory (RAM) 630 for storage of instructions and data during program execution and a read only memory (ROM) 632 in which fixed instructions are stored. A file storage subsystem 626 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 626 in the storage subsystem 624, or in other machines accessible by processor(s) 614.

Bus subsystem 612 provides a mechanism for letting the various components and subsystems of computing device 610 communicate with each other as intended. Although bus subsystem 612 is shown schematically as a single bus, alternative implementations of the bus subsystem may use multiple busses.

Computing device 610 can be of varying types including a workstation, server, computing cluster, blade server, server farm, or any other data processing system or computing device. Due to the ever-changing nature of computers and networks, the description of computing device 610 depicted in FIG. 6 is intended only as a specific example for purposes of illustrating some implementations. Many other configurations of computing device 610 are possible having more or fewer components than the computing device depicted in FIG. 6. In some examples, the machine learning models described herein can be used for controlling a robotic device or a simulated robotic device.

The input to a machine learning model configured with selected aspects of the present disclosure may comprise a natural language description of a task to be performed by the robotic device. For example the input may comprise speech or text data. Speech data may be captured by a microphone on a robotic device or on a separate device for example. Text data may be entered by a user through a keyboard or touchscreen on the robotic device or on a separate device for example, or may be generated from speech data captured by a microphone on the robotic device or on a separate device for example (for example using automatic speech recognition techniques). Thus the input may include textual or spoken instructions provided to the robotic device by a third-party (e.g., an operator). In particular, a user may control the robotic device using a client device such as a tablet computer or smart phone for example.

The input may additionally or alternatively comprise sensor data generated by one or more sensors on the robotic device or in the environment of the robotic device. For example, the input may comprise image data captured by one or more vision sensors such as one or more cameras (e.g., RGB, infrared). The input may comprise a three-dimensional (3D) digital representation of the environment captured by one or more sensors such as LIDAR sensors or depth cameras, for example point cloud data generated using a light detection and ranging (LIDAR) sensor. For example, the input may comprise sensor data from a distance or position sensor, or from an actuator. The input may include data from sensors of the agent or data from sensors that are located separately from the agent in the environment.

The input may include data characterizing the current state of the robot, e.g., one or more of: joint position, joint velocity, joint force, torque or acceleration, e.g., gravity-compensated torque feedback, and global or relative pose of an item held by the robot. The input data may be defined in 1, 2 or 3 dimensions, and may be absolute and/or relative data. The input may also include, for example, sensed electronic signals such as motor current or a temperature signal. The input may include data captured from e.g. one or more force sensors, pressure sensors, pressure wave sensors (e.g., microphones), proximity sensors (also referred to as “distance sensors”), depth sensors, torque sensors, barcode readers, radio frequency identification (“RFID”) readers, radars, range finders, accelerometers, gyroscopes, compasses, position coordinate sensors (e.g., global positioning system, or “GPS”), speedometers, edge detectors, Geiger counters, and so forth.

The output of the machine learning model may comprise data representing one or more tasks to be performed by the robotic device in order to perform the task.

For instance, the output may comprise natural language, for example text or speech, that describes steps or sub-tasks for completing a task. The output may define one or more low-level skills, e.g. from a vocabulary of previously learnt skills.

The output may comprise robot control data that is usable to control a robot to complete the task, for example. The robot control data may include, for instance, low-level actuator commands that directly control actuators of the robotic device, cartesian commands that specify direction(s) for an end effector of the robotic device, a target robot pose, selected predefined robot primitives, and so forth. As an illustration, the output may comprise action tokens, that can be converted into a control signal for the robotic device. For example, the action tokens may represent variables for arm movement (such as one or more of: x, y, z, roll, pitch, yaw, gripper opening), variables for base movement (such as one or more of: x, y, yaw), and variables to switch between modes (such as a variable to switch between controlling arm, controlling base, or terminating the episode). Each action dimension may be discretized, for example into 256 bins.

The output may comprise reward parameters that can be optimized by a low-level motion controller to determine low-level actuator commands.

The output may comprise robot policy code expressing functions or feedback loops that process perception outputs and parameterize control primitive APIs. For example, the output may comprise API calls to generate policy code.

The output may represent candidate robot or end effector trajectories, higher-level control commands, position, velocity, or force/torque/acceleration data for one or more joints, or electronic control data such as motor control data for example.

In various implementations, the robot may be simulated in a virtual environment. The input may comprise data representing the virtual environment in which the simulated robot operates, for example image data representing the virtual environment.

The robotic device may take various forms, including but not limited to a telepresence robot, a robotic arm, a bi-arm robotic device, a humanoid robot or other bipedal robot, a quadruped robot such as a “robot dog”, a wheeled robot, an aquatic robot, and so forth. The robotic device may include control logic. Control logic may take various forms, such as a real time controller, one or more processors, one or more field-programmable gate arrays (“FPGA”), one or more application-specific integrated circuits (“ASIC”), and so forth. In some implementations, the logic may be operably coupled with memory. Memory may take various forms, such as random-access memory (“RAM”), dynamic RAM (“DRAM”), read-only memory (“ROM”), Magnetoresistive RAM (“MRAM”), resistive RAM (“RRAM”), NAND flash memory, and so forth. In some implementations, the control logic may be operably coupled with one or more joints, one or more end effectors, and/or one or more sensors. A joint of a robot may broadly refer to actuators, motors (e.g., servo motors), shafts, gear trains, pumps (e.g., air or liquid), pistons, drives, propellers, flaps, rotors, or other components that may create and/or undergo propulsion, rotation, and/or motion. An end effector may broadly refer to a variety of tools that may be operated by the robotic device in order to accomplish various tasks. For example, an end effector may take the form of a claw with two opposing “fingers” or “digits.” Such a claw is one type of “gripper” known as an “impactive” gripper. The gripper may have more than two digits, for example, three, four or five digits. Other types of grippers may include but are not limited to “ingressive” (e.g., physically penetrating an object using pins, needles, etc.), “astrictive” (e.g., using suction or vacuum to pick up an object), or “contigutive” (e.g., using surface tension, freezing or adhesive to pick up object). More generally, other types of end effectors may include but are not limited to drills, brushes, force-torque sensors, cutting tools, deburring tools, welding torches, containers, trays, and so forth. In some implementations, end effector may be removable, and various types of modular end effectors may be installed onto robot. Some robots, such as some telepresence robots, may not be equipped with end effectors.

While several implementations have been described and illustrated herein, a variety of other means and/or structures for performing the function and/or obtaining the results and/or one or more of the advantages described herein may be utilized, and each of such variations and/or modifications is deemed to be within the scope of the implementations described herein. More generally, all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific implementations described herein. It is, therefore, to be understood that the foregoing implementations are presented by way of example only and that, within the scope of the appended claims and equivalents thereto, implementations may be practiced otherwise than as specifically described and claimed. Implementations of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

What is claimed is:

1. A method implemented using one or more processors and comprising:
retrieving a plurality of images that capture an environment in which a robot operates from multiple different perspectives;
processing data indicative of the plurality of images and a proprioceptive state of the robot using a transformer-encoder to generate latent embeddings representing the plurality of images and proprioceptive state of the robot;
processing the latent embeddings and data indicative of a diffusion timestep using a transformer-decoder to generate robot control data, wherein the robot control data comprises a series of actions to be performed by the robot over a time interval;
causing the robot to be operated in accordance with the robot control data.

2. The method of claim 1, wherein the series of actions comprise a series of absolute joint positions of a plurality of joints of the robot.

3. The method of claim 2, wherein the series of actions further comprise a series of gripper positions for two or more grippers.

4. The method of claim 3, wherein the series of gripper positions are continuous.

5. The method of claim 1, wherein the series of actions comprise:
joint commands and/or torque commands;
Cartesian commands for an end effector of the robot;
a target robot pose; or
code specifying reward functions for motion controller optimization; or selected predefined robot primitives.

6. The method of claim 1, wherein the transformer-encoder and transformer-decoder form a diffusion policy.

7. The method of claim 1, further comprising processing each of the plurality of images using a respective convolutional neural network to generate feature maps.

8. The method of claim 7, further comprising flattening the feature maps into a sequence of tokens that comprise the data indicative of the plurality of images that is processed using the transformer encoder.

9. The method of claim 1, wherein the transformer-decoder comprises a diffusion denoiser.

10. The method of claim 1, wherein the diffusion timestep is represented as a one-hot vector.

11. The method of claim 1, wherein the robot is a simulated robot or a real robot.

12. The method of claim 1, wherein one or both of the transformer-encoder and transformer decoder are trained using training data collected using imitation learning.

13. The method of claim 12, wherein the imitation learning comprises teleoperation of one or more robots using a puppeteering interface.

14. The method of claim 13, wherein the puppeteering interface comprises two leader arms of a first size that are synchronized with two follower arms of a second size that is greater than the first size.

15. The method of claim 13, wherein the imitation learning comprises one or more of the following tasks:
folding a shirt;
hanging a shirt on a hanger;
shoelace tying;
robot finger placement;
gear insertion; or
stacking random collections of dishware.

16. The method of claim 1, wherein at least the transformer-decoder is trained with a diffusion loss.

17. The method of claim 16, wherein both the transformer-encoder and transformer-decoder are trained with diffusion loss.

18. A method implemented using one or more processors and comprising:
retrieving a plurality of images that capture, from multiple different perspectives, an environment in which a robot was operated to perform a sequence of actions;
processing data indicative of the plurality of images and a proprioceptive state of the robot using a transformer-encoder to generate latent embeddings representing the plurality of images and proprioceptive state of the robot;
adding noise to the sequence of actions performed by the robot to generate a plurality of noisy actions;
processing the latent embeddings and the plurality of noisy actions using a diffusion-based transformer decoder to predict noise values;
based on the predicted noise values, training the diffusion-based transformer decoder.

19. The method of claim 18, wherein predicted actions are determined using the predicted noise values, and the diffusion-based transformer-decoder is trained based on a comparison of the predicted actions and the sequence of actions performed by the robot.

20. A system comprising one or more processors and memory storing instructions that, in response to execution by the one or more processors, cause the one or more processors to:
retrieve a plurality of images that capture an environment in which a robot operates from multiple different perspectives;
process data indicative of the plurality of images and a proprioceptive state of the robot using a transformer-encoder to generate latent embeddings representing the plurality of images and proprioceptive state of the robot;
process the latent embeddings and data indicative of a diffusion timestep using a transformer-decoder to generate robot control data, wherein the robot control data comprises a series of actions to be performed by the robot over a time interval;
cause the robot to be operated in accordance with the robot control data.
